(19) United States
(12) Patent Application Publication
(10) Pub. No.: US 2006/0078097 A1
(43) Pub. Date: Apr. 13, 2006

(54) Remote call encoder

(76) Inventors: Robert Herbelin, Wildomar, CA (US); Edward Keyes, San Diego, CA (US); Michael Purdy, San Diego, CA (US)

Correspondence Address: FISH & RICHARDSON, PC, P.O. BOX 1022, MINNEAPOLIS, MN, 55440-1022, US

(21) Appl. No.: 11/198,903

(22) Filed: Aug. 5, 2005

Related U.S. Application Data
(60) Provisional application No. 60/599,501, filed on Aug. 6, 2004.

(51) Int. Cl. H04M 1/64

(52) U.S. Cl. 379/88.22

(57) ABSTRACT

A system apparatus and method for generating streaming audio content includes an encoder computer for receiving, encoding, and storing audio signals, and a telephonic interface coupled to the encoder computer, the telephonic interface having voice and data inputs. A system further includes a telephone coupled to the encoder computer via the telephonic interface, the telephone for providing at least a portion of the audio signals via the voice input and for providing control signals to the encoder computer via the data input.

### CROSS REFERENCE TO RELATED APPLICATIONS

The present application claims priority under 35 U.S.C. §119 to U.S. Provisional Application Ser. No. 60/599,501, filed Aug. 6, 2004, entitled REMOTE CALL ENCODER, the disclosure of which is incorporated herein by reference.

### BACKGROUND

The Internet is fast becoming the medium of choice for a variety of content communication. For example, video and audio content was previously the exclusive domain of television or radio, but is now widely available and accessible via the Internet. The porting of content delivery channels from traditional media to the Internet brings new challenges of managing, organizing and delivering such content. While the ubiquity of the Internet gives rise to tremendous potential, there are still risks to proper control and access to Internet content.

### SUMMARY

This document discloses an apparatus, system and method for generating streaming audio content via a remote call encoder (RCE). According to one aspect an apparatus includes an encoder computer for receiving, encoding, and storing audio signals. The apparatus further includes a telephone connection coupled with the audio encoder computer for receiving telephonic signals representing control commands for the encoder computer.

According to another aspect, a system for generating streaming audio content includes an encoder computer for receiving, encoding, and storing audio signals, and a telephonic interface coupled to the encoder computer, the telephonic interface having voice and data inputs. The system further includes a telephone coupled to the encoder computer via the telephonic interface, the telephone for providing at least a portion of the audio signals via the voice input and for providing control signals to the encoder computer via the data input.

According to another aspect, a method for generating streaming audio content includes connecting a telephone to an encoder computer, the encoder computer being configured to receive, encode and store audio signals. The method further includes transmitting voice and control signals from the telephone to the encoder computer.

The RCE provides at least the following advantages. Multiple program formats can be used for many different types of live remote events. Format selection can be made remotely prior to the event using remote control of the encoder process. Simple “Step” commands (one key) of special keys can be used for specific functions. The RCE also accommodates various Internet set-up formats. Each format can be edited via the Internet before broadcast, and specific audio content can be introduced prior to an event. Event-specific audio can be recorded and selected for use before the live event. All of these files can be transferred via the Internet.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a remote call encoder system and general operational flow thereof.

FIG. 2 is a data and control flow diagram for a remote call encoder system.

FIG. 3 is a flowchart of a setup method of the remote call encoder.

FIG. 4 is a table of parameters used by a remote call encoder system.

FIG. 5 shows an operation of a program using the remote call encoder system.

Like reference symbols in the various drawings indicate like elements.

### DETAILED DESCRIPTION

This document discloses a remote call encoder (RCE) for an audio program, i.e. a set of one or more digital audio files that are related in some way, such as by originator, subject, time, etc. The RCE handles definition and setup of multiple program formats and associated audio files. The RCE can be operated locally on a computer workstation through graphical buttons on a display screen, or remotely using a telephone keypad via a phone interface or through a messaging system using a network such as a wireless network and/or the Internet.

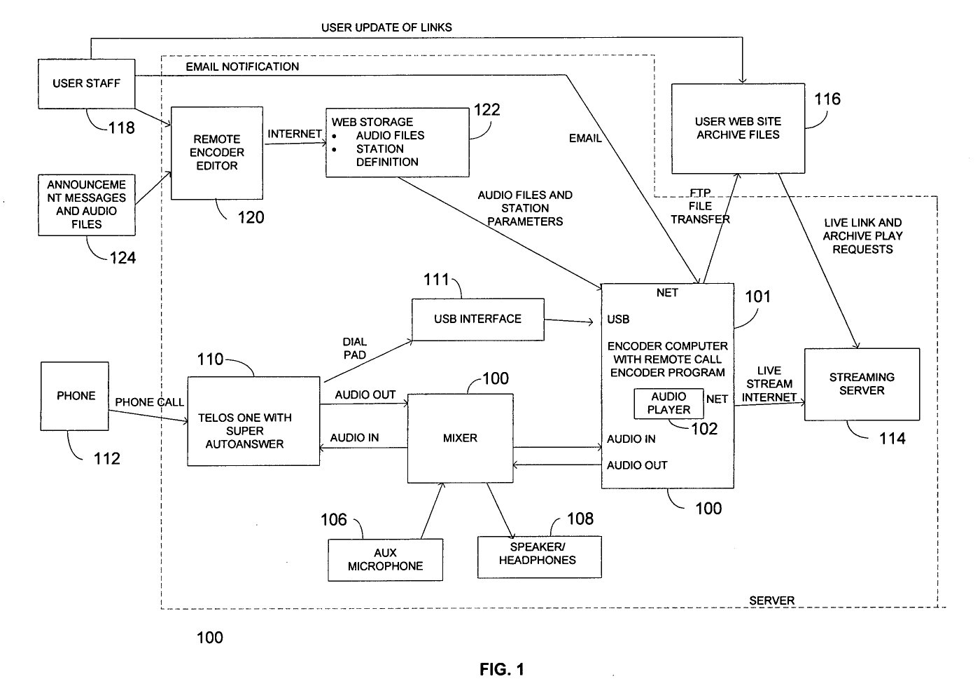

FIG. 1 illustrates an RCE system 100 having an RCE 101 that includes software modules that create and control an audio player system 102 and associated audio sources, such as an audio mixer 104, auxiliary input such as a microphone 106, and auxiliary output such as speakers or headphones 108. One example of an audio player system 102 is a Windows™ Media 9 Series Encoder provided by Microsoft Corporation of Redmond, Wash. The audio player system 102 is used to synchronously play back audio files submitted to the RCE system 100. The RCE 101 and audio player system 102 can be hosted on a common computer, or across a network of computers.

Control of the audio and the program is provided remotely through a telephone interface 110. One example of the telephone interface 110 is a Telos One Digital Hybrid Telephone Interface having a Super Auto-Answer board and a universal serial bus (USB) computer interface 111 for connecting to the audio player system 102. Telephonic signals such as keypad tones from a phone 112 are used for controlling the audio player system 102. The phone 112 can be any type of telephonic device, such as a landline phone, a wireless phone, or other device having telephonic capability. The receiver of the phone 112 is used for an audio source and the ear piece of the user phone 112 provides feedback of encoder output, except during a live broadcast portion when the ear piece can be suppressed.

The RCE 101 selects and streams audio content to a media server 114. In an embodiment, the media server 114 “pulls” the streaming audio content from the RCE 101. According to some embodiments, archive files of a live portion of the audio are created, and uploaded using a file transfer protocol (FTP) transfer to a user web site 116 for playback. Electronic mail (email) notification from a user staff computer 118 is used to alert a web master of the user web site 116 of an availability of the archive file.

Program and media formatting is performed using the RCE 101 directly or via the Internet using an RCE editor 120 under control of the user staff computer 118. The RCE editor 120 also controls the transfer of audio files for use by the RCE 101, to provide the ability to prepare and play specific pre-recorded media, such as announcement messages and audio files 124, before and after a live event.

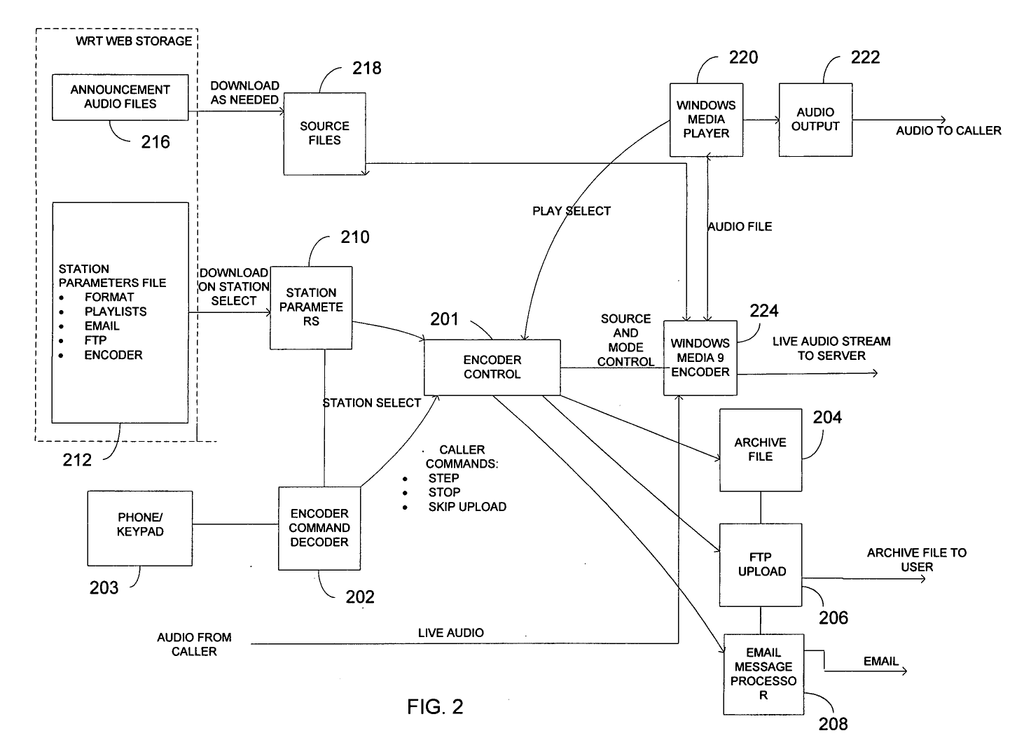

As illustrated in FIG. 2, an RCE 201 responds to tone commands decoded by an encoder command decoder 202 from a phone 203 used by a remote caller that provides a live stream of information. The RCE 201 generates an archive file 204 of the information, and uploads the recorded information via FTP upload 206. An email message processor 208 under control of the RCE 201 generates an email notification 104 to update a web site. The remote caller, via the phone 203, can configure station parameters 210 to select a program format from a set of customized predefined program formats 212, and control the progress of the broadcast. The predefined program formats 212 include a station format, playlists, e-mail addresses, FTP options, and encoder settings.

The program format and audio content are selected prior to the broadcast by a remote caller or by an administrator, and saved in one or more format definition tables provided by the predefined program formats 212. The format definition tables define the content to be streamed. The stream pattern and program format can be customized with several options. According to one option, a program loop of source files 218 can be played before and after a live event. The source files 218 can be local audio files and include announcements 216 of the live event or an upcoming event, or of other regular programming. The source files 218 may also include an introduction of the live event. The introduction provides feedback via a media player 220 and audio output 222 to the broadcast caller as to when to start and informs the listener that the live broadcast is about to start. The live event can be followed by a follow-up announcement. This follow-up announcement can be played once, or repeated (looped) until commanded to stop. This announcement can direct listeners to a web site to replay the broadcast or obtain more information. After the live event, the RCE 201 can stop or return to the next item in the program loop that was interrupted.

Program selection, and each step of the program, are under control of the remote caller using the number pad on the phone 203. Broadcast files are played to the remote caller while they are streamed to an audience. The remote caller will not hear their input during the live portion of the broadcast, in which an in-studio announcer can also be included. Source and mode control of a program are provided to a media encoder 224, for live audio streaming to a media server (not shown). Program formats and content are defined using web pages connected with the RCE 201, so as to be able to change formats and/or upload new audio content for a program prior to the actual broadcast. Accordingly, the broadcast can be specific to an event rather than a generic announcement.

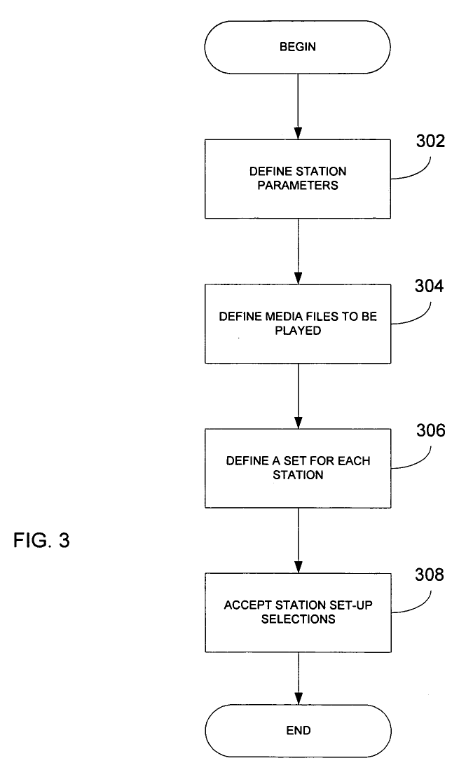

In some embodiments, and as shown in FIG. 3, the RCE program 108 operates according to a remote encoder method 300. At 302, station parameters are defined. These parameters define the location of information, encoder parameters, archive parameters and email parameters. In some embodiments, these station parameters are set up only once. A web page representing the “station” can be used to change these values. Up to nine configurations can be defined corresponding to the nine numbers on the phone. At 304, media files to be played are defined on a “sources” page. These include an introduction file, an exit file and one or more loop program files. At 306, a set is defined for each station. The set-up selections are accepted at 308, and the encoder is then ready. At this point the encoder can be controlled manually by screen “buttons” or remotely by the phone, including a change of station.

The following remote commands can be defined using the numeric dial pad of the phone 203. The system will automatically answer calls but not change state until commanded through these commands. Any number of calls can be used to control the progress. The caller does not have to stay on the phone except for the live portion. Each remote command can correspond to a key on the numerical dial pad of the phone 203, as shown by way of example below:

Key: 1—Step through the program format.

Key: 2—Stop the encoder. Used in the case of looping to stop encoder. If not looping, encoder will stop at end of the program.

Key: 3—Drop archive upload and email. Used to cancel broadcast. This selection must be selected during the live broadcast.

Key: # plus number—Prepare for a change of station parameters. The number following this key is the station number. This command will terminate any broadcast in process, if active, and switch to the new format.

The following describes the use of the “step and stop” commands in a typical operation. The RCE is not started until commanded. First, a prepared loop is broadcast to announce the fact that an important message is made shortly. For example, a short introduction is used to queue the live news report. A looping exit message is then provided, directing the listener to look to the archives to replay the announcement. Return to the prepared announcement loop. The RCE will continue streaming until commanded to stop at the end. The format would appear as: start, program loop, introduction, live broadcast, exit loop, program loop, stop. Table 1 illustrates an example of the operation of a program.

TABLE 1

| | News Broadcaster | |
|---|---|---|
| Event | Action | Encoder Action |
| News broadcaster | Calls encoder and | The encoder will |
| receives notice of | issues a #3 command | prepare source files |
| a news event. | to select format #3 | and format for format |
| | | #3. |
| | Calls encoder and | The encoder will start |
| | issues a “Step” | streaming, sending the |
| | command to start the | prepared announcement |
| | process. | loop. |
| | Hangs up after hearing | |
| | the beginning of the | |
| | announcement.. | |
| News broadcaster | Calls encoder and | The encoder will jump |
| arrives at the scene | issues a “Step” | to the short |
| and is prepared to do a | command. | introduction. After the |
| live broadcast. | | introduction, the |
| | | encoder will begin the |
| | | live broadcast. |
| News broadcaster | Begins the live | Encoder is streaming |
| hears the end of the | broadcast. | the live content. |
| introduction. | | Archive file is being |
| | | generated. |
| Report is finished. | Issues a “Step” | The live input will |
| | command. May hang | terminate and the exit |
| | up at this time. | message will begin. |
| | | In this example it will |
| | | loop. |
| | | When complete, the |
| | | archive |
| | | file is uploaded and |
| | | an email sent to |
| | | announce the new file |
| | | is ready. |
| News broadcaster | May hang up at this | |
| hears the exit message. | time. | |
| After a proper loop | Calls encoder and | The encoder will |
| interval | issues a “Step” | return to the |
| | command | announcement loop |
| | | and continue. |
| Later | Calls encoder and | Encoder shuts down. |
| | issues a “Stop” | |
| | command | |

The RCE can include a user interface having a number of screens or pages. These are selected using tabs or buttons at the top of the screen or page. Several pages have buttons to return to the main “Encoder” page, which can be configured as the main page. The “Encoder” page includes three major sections, arranged from top to bottom on the display. The top section has the encoder controls and status. The middle section lists the audio files to play or record. The bottom section includes a link to a Setup program.

There are three sections in the Setup program: 1) Station Parameters: a display panel provides access to a station parameters page. Default station parameters are loaded when the program is loaded. Station number and parameters are changed on the Station page. 2) Reload Station Parameters: a “Reload Station Parameters” button reloads the current selection. This insures that changes will take effect. 3) Edit Station Parameters: Takes the user to the Station page. This is the same as selecting the “Station” tab. Another panel selects the format to follow. The user checks or otherwise selects the appropriate boxes for the desired program.

The Program Loop is checked to play one or more files in sequence while waiting for a live event. The program files are defined under a Sources page. If selected, the encoder will begin playing these sources when started. These files are heard by the caller after the encoder starts. The Intro Announcement is checked to play an introductory announcement file. This helps the caller time the start of his live broadcast. If checked, the encoder will play this file before the live session. This file is heard by the caller.

The Outro Announcement is checked to play an exit message. In an embodiment, at least ten seconds of file of material is played after the live session to complete archiving. This file or program looping is used to provide material after the live broadcast. The loop on Outro Announcement is checked to repeat the exit message. The message will loop until commanded to stop. The commands of “Encoder Start,” “Intro Start,” “End of Live,” and “End of Outro Loop” are sequenced by the caller or accessed by a user using an appropriate screen button. The command “Encoder Stop” uses a separate caller command to distinguish it from the “Encoder Start” command.

When Setup Complete is provided, the a panel in the display registers the selections and enables the encoder. An “Accept Configuration” can be pressed when station parameters, sources and format are configured. This is necessary to prepare the encoder. Encoder start, Intro start, End of live, End of Outro loop, and Encoder stop are sequenced by the caller or by using an appropriate screen button.

The controls and indicators provide manual control and monitoring of the encoder. The current time is indicated in one of the panels. The panels can be provided in the display as horizontal panels, the horizontal panels including: encoder controls, encoder status, recording and archive status, and output connections. The current date and time are displayed for information. There are several diagnostic messages at the bottom this panel indicating the last remote request. These are mainly for test purposes.

A number of manual controls are also included and represented as buttons on a display. The “Start” control initiates the encoder. This button is not active until the “Accept Configuration” button has been pressed. When the encoder is running, this button is inactive. An “End File” button stops the current source and switch to the next source. The label “End File” is present when playing a stored file. The label changes to “End News” when live input is being streamed. This control can be displayed as a particular color, such as green, when a file is being played. At the start of the live session it is disabled until the archive file is started (preferably about seven seconds after start). At that time it will turn into another color, such as red, to indicate that the live broadcast can be stopped.

A “Start News” button transfers the encoder to the first item programmed in the news sequence. This is either the Intro if “Intro Announcement” is checked or the live broadcast if it is not checked. If the encoder was started and is looping, the looping will stop. If not, the encoder is started. This button, like the Start button, is not enabled until “Accept Configuration” has been pressed.

A “Stop” button will stop the encoder. This button is not active while starting or processing live input. When pressed, the encoder goes through a stopping process. Note that the program cannot close unless the encoder is stopped. An “Upload and Log” button will force an FTP transfer of the last archived file. This operation is normally automatic and is not used unless the upload process fails. A “Change Station” button simulates a remote station change request. When pressed, a dialog box appears with a request for a station selection. Once made, the encoder is stopped, and if active, the new station is selected, and the new parameters are set.

Other controls include “Current File Status” and “Player Panel.” The “Player Panel” shows file length, time played, time remaining, encoder status and player monitoring. The metrics shown in these controls include “Length”—the length of the file playing, which is established when the file is assigned as a source. This value is zero for a live portion. Other metrics include: “Played”—the amount of time the current source, file or live, has been playing; and “Time To Go”—the amount of time that remains for the current file. This number is negative for the live portion since the play time for live is zero. The metrics further include “Encoder Status”—provided on the display as a color, which in one embodiment can change from inactive (grey), to transitioning (yellow) to streaming (green).

Still other controls/status include: “Player”—The media player operated in parallel with the encoder on the same recorded file. The encoder is synchronized with the player, which provides audio feedback of what the encoder is playing without the delay of the encoder (which can be approximately 10 seconds). The player output is sent back to the caller so that the caller can monitor what is occurring. A check box or other graphical designation is provided to disable the player. If disabled, the caller will not hear anything.

Archiving Panel—The Archiving panel indicates when the live broadcast is occurring and the status of the archive process. A Running Box—a box on the left of the panel, can turn green with the word “Recording” when live input is streaming. The player is off and the caller should be making his comments. This also indicates when a studio host can use the studio microphone. About seven seconds after recording begins, the archive output will begin. At this time, the End News button will turn red as input may be cancelled from this point on.

Archiving Indicators—The archive panel will turn green when the archive output begins. The word “Archiving” can be programmed to appear. The file name, file size and duration are listed as the file is built. This activity will carry on for about seven seconds beyond the end of the recording period. During these last seven seconds, the encoder must have other material to play and can not be stopped. The last few seconds of the live broadcast is dropped from the archive file, and the End News command is suppressed over the phone.

Output Panel—Connections to the encoder are displayed on the output panel. Connections made and dropped are displayed. The IP address list contains the sites currently “pulling” content from the encoder. The server acting as the broadcast point for the station should always be among the list of IP addresses.

Encoder Source Lists—a number of sources are prepared for encoder operation. Sources define the input parameters for streaming. These sources are displayed in the center pane and are described below. The active source is highlighted. All source file selections are made on the Source page. All sources must be defined even if not used as the encoder checks the file names before starting. Default sources are put into any unfilled source since the encoder will check for files before starting.

Loop 1 and Loop 2—provide alternating sources for program loops. When one loop source is playing, the alternate loop source is prepared for the next file. Thus, any number of files can be played in the loop. When the loop is interrupted for a news broadcast, the current loop source is stopped. After the news broadcast, loop playing will resume with the next loop source. The encoder can not be resumed in the middle of a file.

Intro—the Introduction Announcement file. It should be short, and optional. The Intro queues the broadcaster as to when to start the live broadcast, and alerts the listener to the news content.

Live News—this does not have a file name, and uses the live input. The file name is created when the news broadcast begins. The name incorporates the date and time of the broadcast for identification purposes.

Outro—the Exit Announcement file that ends the broadcast. It is optional if there is a program loop.

A Sources Page is provided to select material to play. In an embodiment, there are three major panels on this page. The top panel provides information and a button to return to the encoder page. Also included is a player. This player can be used to determine the length (duration) of a file. The player will play the last file selected on the panels below. This player should not be used while the encoder is active as it will conflict with the player on the encoder page.

News Sources Panel—to select the Intro and Outro files. Files are stored in categories. Use the “Type” selection for the file category. The file sub directory and file name are selected with the “Select Intro” and Select Outro” buttons. These buttons will bring up a windows file dialog box for file selection. The desired file is found and selected. The player in the top panel is used to get the file length. The file is played for a second and the length is available. The “Get File Length” is also pressed. The player is then stopped if not already done so. The buttons “Set Intro Length” and/or “Set Outro Length” are pressed to save the length listed with the player. The Intro and Outro selection are saved as Station Parameters.

The Loop Sources Panel includes a selection panel on the left and a list of source files on the right. The buttons and controls are used to retrieve, create, edit and save source file selections. Type, Duration and File Name are entered with other controls. A “Seq” entry is covered at the end of this section. A control button “Reload List” restores the last saved list for the currently selected station. The file category is selected with “Type.” A control “Add File” creates a new item (record). A control button “Select File” brings up a file selection window in the selected category, to enable selection of the desired file. “Set Length” is used to fill in the file length (duration). The player in the top panel is used to play the last selected file and find the length. “Set Length” is pressed to copy the value displayed.

Delete File—this button displays a message telling how to delete a line by selecting the line and pressing the delete key on the keyboard. Save List—saves the edited list with Save List under the current station number.

Play Sequence—Files are played by sequence number (Seq) rather than in the order entered. The Seq column is edited to provide the desired order. The row is selected to change the value. Another row is selected and the previous value is automatically saved. The source list can be saved if it is to be used again. Station parameters deal with basic encoder definitions. These are saved in a station definition file for each station. The Station Page provides the means to view and edit these files.

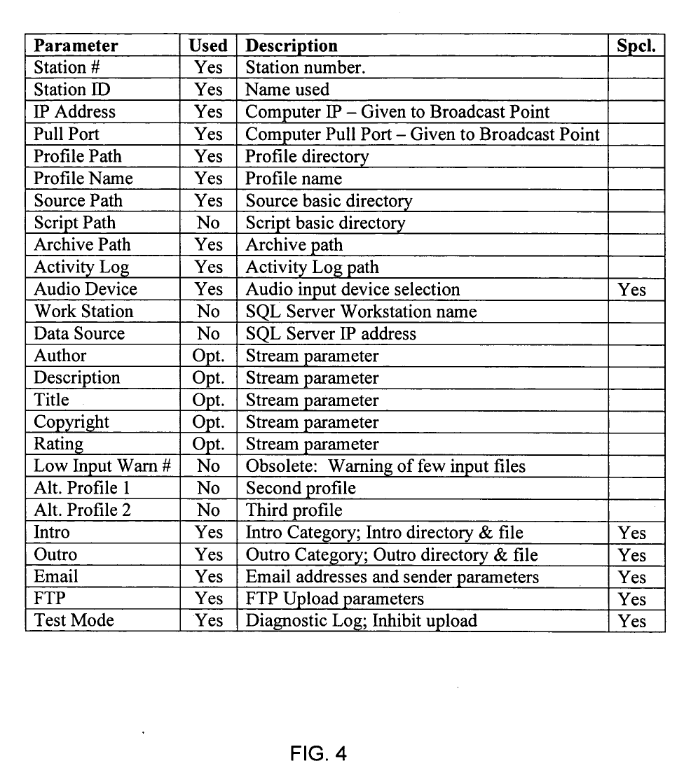

Parameter Definition: FIG. 4 shows the parameters defined for a station and/or program. Not all parameters are used with every encoder. Tools are provided to fill in “Spcl.” Items. In an embodiment, Viewing and Editing Parameters are also provided.

Station #—The encoder program can support multiple encoder definitions and Broadcast Points. The station number to use can be selected. This selects the Station Parameters file, Sources file and Log files. Multiple stations can be defined for one encoder. The default is 1 for normal operations, and other numbers are used for special circumstances. For example, the parameters and sources for station 1 are loaded when the program begins. The controls “View Parameters” reloads the selected station parameters, and “Return to Encoder” selects the Encoder page just like selecting the page tab.

The following controls are disabled unless enabled on the Maintenance page. Data cannot be changed unless enabled. “New Row” adds a new row. The parameter to enter first can be selected as the parameter is set to the parameter selected in Parameter Select box. “Parameter Select” is used to select a parameter. The value selected is used with New Row and Set Parameter buttons. “Set Parameter” sets the parameter value of the selected row to the value in Parameter Select.

Some values have special formats. A “Build Special Value” button will build the value for the selected row if it is one of the special parameters. There is no action for non-special parameters, as shown in FIG. 4. “Save Changes” writes the new set of records to the station parameters file of the selected station with Save Changes. This is required whenever you want to save changes to the Intro or Outro selection, email selections or FTP selections.

Registered audio devices on the computer are listed in an “Audio Device Selection” box. This is the input audio source for the live broadcast. Usually the Default_Audi_Device selection is used. This value can be copied to the Audio Device value. “Activity Log Page” lists the events that occur. Full details are recorded in the diagnostic mode. A summary of major events are recorded otherwise. The content of this page is added to an activity log file. Diagnostic mode is selected on the Maintenance Page.

“Clear Summary” used to clear the activity log list. Clearing the list does not clear the log file that is written in parallel with this list. “Maintenance Page” provides special diagnostic and emergency controls. It also contains email and FTP parameters. “Processing Time” shows the maximum time taken for some processes during the current session of the program. It is used to verify that events are completed in a timely manner. Delays should not exceed several seconds.

Selecting “Full Diagnostic Log” logs all diagnostic messages. This is useful for troubleshooting. This box is deselected for normal use. This is the first parameter in the station parameter Test Mode. It is formatted as a special parameter.

“Enable/Disable Edit Station Parameters”—selecting this button enables or disables editing of station parameters. The name changes to display the operation that is performed. “End Live” and “Stop Encoder” are emergency controls to perform these actions independent of other control conditions. They are active even if the controls on the Encoder page are not. Selecting “Test only. No FTP or Email” will inhibit FTP upload and Email operations. Use this for testing only. It is the second parameter of the station parameters Test Mode. It is formatted as a special parameter.

Email parameters can be used to define the email to be sent after recording and uploading a news broadcast. Multiple addresses can be entered, separated by commas. The “From Address” and “SMTP Mail Server” are required to define the sender. These values are placed in the station parameters Email parameter. Use the “Build Special Values” button on that page. FTP Host, User, and Password are required to sign on to the archive server. These values are placed in the station parameters FTP parameter. The Build Special Values button on that page can be used.

Archive file information includes an Archive File Name. The uploaded file name will include: News-yymmdd-hhnn.wma where, for example:

yy=year, mm=month, dd=day, hh=hour and nn=minute.

An e-mail message will include:

Subject News Broadcast Upload:

Following items separated by a semicolon:

Date in yymmdd format 040721

Station ID 1

Broadcast Time in hh:nn:ss format 21:13:15.7

Length in hh:nn:ss format 15

Type (Category) Blank (Not specified)

Local file path and name C:\wtr\StudioDir\

Shows\News-04072 1-2113.wma

The following line is a message example with the above values:

News Broadcast Upload: 040721; 1;21:13:15.7; 15;;C:\wtr\StudioDir\Shows\News-04072 1-2113.wma

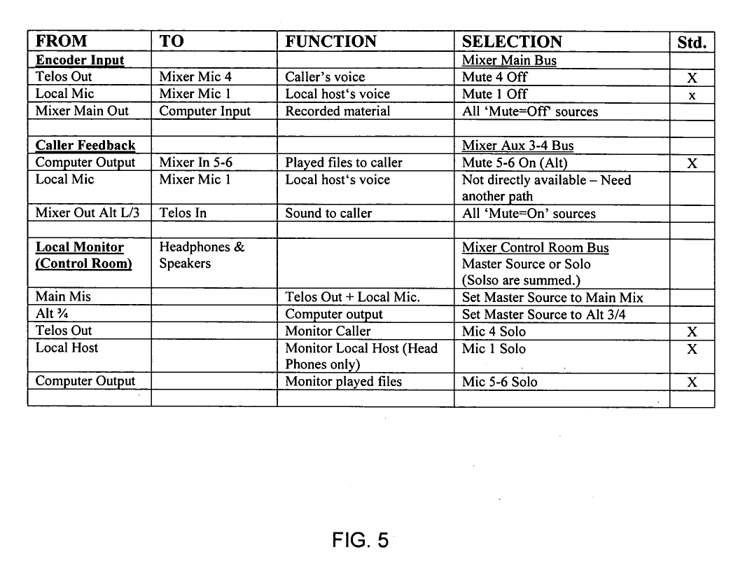

FIG. 5 is an example of a display showing a mixer setup with the Telos phone system and computer audio interface for audio setup. The mixer provides monitoring and the addition of an In-Studio host.

Although a few embodiments have been described in detail above, other modifications are possible. Other embodiments may be within the scope of the following claims.

1. An apparatus for generating streaming audio content, the apparatus comprising:
an encoder computer for receiving, encoding, and storing audio signals;
a telephone connection coupled with the audio encoder computer for receiving telephonic signals representing control commands for the encoder computer.

2. An apparatus in accordance with claim 1, further comprising a network interface coupled with the encoder computer for streaming at least a portion of the stored audio signals to a server over a network.

3. An apparatus in accordance with claim 1, further comprising a telephone having a keypad, wherein the keypad includes a number of user-activated keys that are configured to generate the telephonic signals representing control commands.

4. An apparatus in accordance with claim 1, further comprising an audio interface coupled with the encoder computer for sending and receiving the audio signals to and from an audio mixer.

5. An apparatus in accordance with claim 2, wherein the encoder computer further comprises a display for displaying an encoder control web page received from a remote server over the network interface.

6. An apparatus in accordance with claim 2, wherein the encoder computer includes a storage for receiving audio files from a remote storage over the network interface.

7. An apparatus in accordance with claim 5, wherein the encoder control web page includes a number of control buttons for configuring the receiving, encoding and storing of the audio signals.

8. A system for generating streaming audio content, the system comprising:
an encoder computer for receiving, encoding, and storing audio signals;
a telephonic interface coupled to the encoder computer, the telephonic interface having voice and data inputs;
a telephone coupled to the encoder computer via the telephonic interface, the telephone for providing at least a portion of the audio signals via the voice input and for providing control signals to the encoder computer via the data input.

9. A system in accordance with claim 8, further comprising a streaming audio server connected to the encoder computer, the streaming audio server receiving stored audio signals in a file format for being streamed to the Internet.

10. A system in accordance with claim 8, further comprising a remote encoder editor coupled to the encoder computer, the remote encoder editor for configuring the encoder computer and providing audio files for mixing with the audio signals.

11. A system in accordance with claim 8, further comprising an audio mixer coupled to the encoder computer and the telephonic interface, the audio mixer for adjusting the audio signals from the encoder computer or the telephone.

12. A system in accordance with claim 11, further comprising a microphone connected to the audio mixer for providing auxiliary audio inputs.

13. A system in accordance with claim 11, further comprising an audio output device connected to the audio mixer for providing audible audio output signals.

14. A system in accordance with claim 8, further comprising an archive storage device for archived encoded and stored audio signals in the form of audio files.

15. A system in accordance with claim 8, wherein the encoder computer further comprises an audio player program.

16. A system in accordance with claim 8, wherein the encoder computer further comprises a display that displays an encoder control program graphical user interface.

17. A method for generating streaming audio content, the method comprising:
connecting a telephone to an encoder computer, the encoder computer being configured to receive, encode and store audio signals; and
transmitting voice and control signals from the telephone to the encoder computer.

18. A method in accordance with claim 17, further comprising configuring the encoder computer with the control signals from the telephone.

19. A method in accordance with claim 17, further comprising storing encoded audio signals in the encoder computer as audio files.

20. A method in accordance with claim 19, further comprising transmitting the audio files from the encoder computer to a streaming audio server.
